(19) United States
(12) Patent Application Publication
(10) Pub. No.: US 2022/0410525 A1
(43) Pub. Date: Dec. 29, 2022

(54) LAYERED SOUND-ABSORBING MATERIAL

(71) Applicants: JNC CORPORATION, Tokyo (JP); JNC FIBERS CORPORATION, Tokyo (JP)

(72) Inventors: Takayuki HATTORI, Shiga (JP); Hidemi ITO, Shiga (JP)

(73) Assignees: JNC CORPORATION, Tokyo (JP); JNC FIBERS CORPORATION, Tokyo (JP)

(21) Appl. No.: 17/620,741

(22) PCT Filed: Mar. 16, 2020
(86) PCT No.: PCT/JP2020/011334

§ 371 Date: Dec. 20, 2021

(30) Foreign Application Priority Data
Jun. 21, 2019 (JP) 2019-115761

(51) Int. Cl. B32B 5/26; B32B 5/02; B32B 5/18; B32B 5/24; G10K 11/168

(52) U.S. Cl. CPC B32B 5/26; B32B 5/022; B32B 5/024; B32B 5/18; B32B 5/245; G10K 11/168; B32B 2262/0284; B32B 2262/0253; B32B 2262/101; B32B 2262/14; B32B 2262/0238; B32B 2262/0261; B32B 2262/0246; B32B 2262/023; B32B 2262/0292; B32B 2266/025; B32B 2266/06; B32B 2307/72; B32B 2307/732; B32B 2307/724; B32B 2307/102

(57) ABSTRACT

A sound-absorbing material has an excellent sound absorbing property in a low-frequency range, an intermediate-frequency range, and a high-frequency range. The sound-absorbing material is a laminated sound-absorbing material, which includes at least one first layer, and at least one second layer that differs from the first layer. The first layer has a mean flow pore diameter of 2.0 to 60 μm and an air permeability according to the Frazier method of 30 to 200 cc/cm²·s. The second layer is a layer including at least one kind selected from a foamed resin, a nonwoven fabric and a woven fabric, has a thickness of 3 to 40 mm, and has a density that is lower than the first layer and is 51 to 150 kg/m³. The first layer is disposed on a sound incidence side of the second layer.

### FIELD OF ART

The present invention relates to a sound-absorbing material of a laminated structure made by laminating a plurality of layers.

### BACKGROUND ART

A sound-absorbing material is a product having a function of absorbing sound and is often used in the field of construction and the automotive field. Using a nonwoven fabric as a material constituting a sound-absorbing material is well known. For example, Patent Literature 1 discloses a multilayer article having a sound absorbing property that includes a support layer and a submicron-fiber layer laminated on the support layer. It discloses that the submicron-fiber layer has a median fiber diameter of less than 1 μm and an average fiber diameter in a range of 0.5 to 0.7 μm and is formed by molten-film fibrillation and electrospinning. An example in Patent Literature 1 discloses one wherein a polypropylene spunbonded nonwoven fabric of a basis weight (grammage) of 100 g/m² and a diameter of approximately 18 μm is made to be the support layer and submicron polypropylene fibers of a grammage of 14 to 50 g/m² and an average fiber diameter of approximately 0.56 μm are laminated thereon. Moreover, another example discloses a multilayer article wherein electrospun polycaprolactone fibers of a grammage of 6 to 32 g/m² and an average fiber diameter of 0.60 μm are laminated on a carded web of polyester fibers of a grammage of 62 g/m². The multilayer articles produced in the examples have their acoustic absorption characteristics measured and are shown to be provided with acoustic absorption characteristics superior to acoustic absorption characteristics of the supports alone.

Furthermore, using a foam as a sound-absorbing material is also known. For example, Patent Literature 2. discloses a laminated structure that improves acoustic comfort (reduction and optimization of a sound reflection component) and thermal comfort, wherein an organic-polymer foam having an open porosity in a specific range is provided as a supporting layer, a glass fabric having a specific ventilation resistance is provided as a surface layer, and a discontinuous adhesion layer is provided between the supporting layer and the surface layer. As the organic-polymer foam, those whose base material is a polyurethane, particularly a polyester urethane, Neoprene (registered trademark), a silicone, or melamine are mentioned, and it is disclosed that a density thereof is preferably 10 to 120 kg/m³ and a thickness thereof is preferably 1.5 to 2.5 mm.

Patent Literature 3 discloses a multilayer sheet used as an automotive insulator. In the multilayer sheet of Patent Literature 3, a first porous sheet and a second porous sheet are fused and integrated by a melt-blown nonwoven fabric made of polypropylene inserted therebetween. As the first porous sheet and the second porous sheet, an adhesive entangled nonwoven sheet of short fibers, a glass-wool-mat sheet, and the like are illustrated. It is thought that inserting a melt-blown nonwoven fabric made of polypropylene that is dense and has low air permeability therebetween and using as the melt-blown nonwoven fabric one whose average fiber diameter is 2 μm or less enables fiber dispersion to be uniform and enables the physical property of low air permeability had by the melt-blown nonwoven fabric to be retained even if melting occurs during molding.

### PRIOR-ART LITERATURE

### Patent Literature

[Patent Literature 1] JP 2014-15042 A

[Patent Literature 2] JP 2014-529524 A

[Patent Literature 3] JP 2016-137636 A

### SUMMARY OF INVENTION

### Problem to Be Solved by Invention

As above, laminates of various configurations are considered as sound-absorbing materials, and combining a plurality of layers of different fiber diameters and air permeabilities (densities) is also known. Meanwhile, as an automotive sound-absorbing material in particular, a sound-absorbing material having superior sound absorption characteristics—in particular, a sound-absorbing material that exhibits an excellent sound absorption performance in a low-frequency range of 1,000 Hz or lower, an intermediate-frequency range of 1,600 to 2,500 Hz, and a high-frequency range of 5,000 to 10,000 Hz and has excellent space-saving properties—is being sought. In view of these circumstances, the present invention has as an object to provide a sound-absorbing material that has an excellent sound absorbing property in a low-frequency range, an intermediate-frequency range, and a high-frequency range.

### Means for Solving Problem

The present inventors conducted research to solve the above problem. As a result, they found that in a laminated sound-absorbing material that includes two kinds of mutually different layers, providing a structure that includes a dense first layer having a mean flow pore diameter in a specific range and air permeability in a specific range and a sparse second layer made of at least one kind selected from the group consisting of a foamed resin, a nonwoven fabric, and a woven fabric can solve the problem, thereby completing the present invention.

The present invention has the following configuration.

[1] A laminated sound-absorbing material, including: at least one first layer, and at least one second layer that differs from the first layer, wherein

the first layer has a mean flow pore diameter of 2.0 to 60 μm and an air permeability according to the Frazier method of 30 to 200 cc/cm²·s,

the second layer is a layer including at least one kind selected from the group consisting of a foamed resin, a nonwoven fabric and a woven fabric, has a thickness of 3 to 40 mm, and has a density that is lower than the first layer and is 51 to 1:50 kg/m³, and

the first layer is disposed on a sound incidence side of the second layer.

[2] The laminated sound-absorbing material according to [1], wherein the second layer is a layer including a nonwoven fabric or a woven fabric including: at least one kind of fibers selected from the group consisting of polyethylene terephthalate fibers, polybutylene terephthalate fibers, polyethylene fibers, polypropylene fibers, glass fibers, and natural fibers, or composite fibers wherein two or more kinds selected from the group consisting of polyethylene terephthalate, polybutylene terephthalate, polyethylene, polypropylene, glass, and a natural material are composited.

[3] The laminated sound-absorbing material according to [1] or [2], wherein the first layer includes fibers including at least one kind selected from the group consisting of polyvinylidene fluoride, nylon 6,6, polyacrylonitrile, polystyrene, a polyurethane, a polysulfone, polyvinyl alcohol, polyethylene terephthalate, polybutylene terephthalate, polyethylene, and polypropylene.

[4] The laminated sound-absorbing material according to any one among [1] to [3], wherein each of the first layer and the second layer is one layer.

[5] The laminated sound-absorbing material according to any one among [1] to [4], wherein a sound absorption coefficient according to a vertical-incidence sound absorption coefficient measurement method at frequencies of 500 to 1,000 Hz is improved by 0.03 or more compared to a sound absorption coefficient of a case in which only one second layer included in the laminated sound-absorbing material is present.

[6] The laminated sound-absorbing material according to any one among [1] to [5], wherein a sound absorption coefficient according to a vertical-incidence sound absorption coefficient measurement method at frequencies of 1,600 to 2,500 Hz is improved by 0.03 or more compared to a sound absorption coefficient of a case in which only one second layer included in the laminated sound-absorbing material is present.

[7] The laminated sound-absorbing material according to any one among [1] to [6], wherein a sound absorption coefficient according to a vertical-incidence sound absorption coefficient measurement method at frequencies of 5,000 to 10,000 Hz is improved by 0.03 or more compared to a sound absorption coefficient of a case in which only one second layer included in the laminated sound-absorbing material is present.

### Effects of Invention

According to the present invention, which has the above configuration, by having a first layer of a specific configuration (also referred to as a fiber layer hereinbelow) and a second layer of a specific configuration (also referred to as a porous layer hereinbelow) in a laminated sound-absorbing material, a high sound absorbing property can be realized with a small number of layers, and a thickness of the sound-absorbing material can be reduced. Moreover, according to the present invention having the above configuration, a sound-absorbing material is obtained that has excellent sound absorption characteristics in a low-frequency range, an intermediate-frequency range, and a high-frequency range. The laminated sound-absorbing material of the present invention has a peak of the sound absorption characteristics in a region lower than a conventional sound absorbing material and has an excellent sound absorption performance in a region of 2,000 Hz and lower—in particular, a region of 1,000 Hz or lower. In the field of construction, it is said that most noise from daily life is at about 200 to 500 Hz, and in the automotive field, it is said that road noise is at about 100 to 500 Hz, noise during acceleration or transmission shifting is at about 100 to 2,000 Hz, and wind noise during vehicle travel is at about 800 to 2,000 Hz. The laminated sound-absorbing material of the present invention is useful as a countermeasure against such noise. Moreover, because the laminated sound-absorbing material of the present invention is thinner and lighter compared to a sound-absorbing material made of only a porous material or glass fibers, member weight reduction and space savings are possible. This is makes it particularly useful as a sound-absorbing material for the automotive field.

### BRIEF DESCRIPTION OF DRAWINGS

FIG. 1 is a graph illustrating sound absorption characteristics of an example of the present invention (Example 1) and Comparative Example (as “Comp. Ex.” in all figures) 1.

FIG. 2 is a graph illustrating sound absorption characteristics of an example of the present invention (Example 2) and Comparative Example 2.

FIG. 3 is a graph illustrating sound absorption characteristics of an example of the present invention (Example 3) and Comparative Example 3.

FIG. 4 is a graph illustrating sound absorption characteristics of an example of the present invention (Example 4) and Comparative Example 3.

FIG. 5 is a graph illustrating sound absorption characteristics of an example of the present invention (Example 8) and Comparative Example 8.

FIG. 6 is a graph illustrating sound absorption characteristics of an example of the present invention (Example 14) and Comparative Example 8.

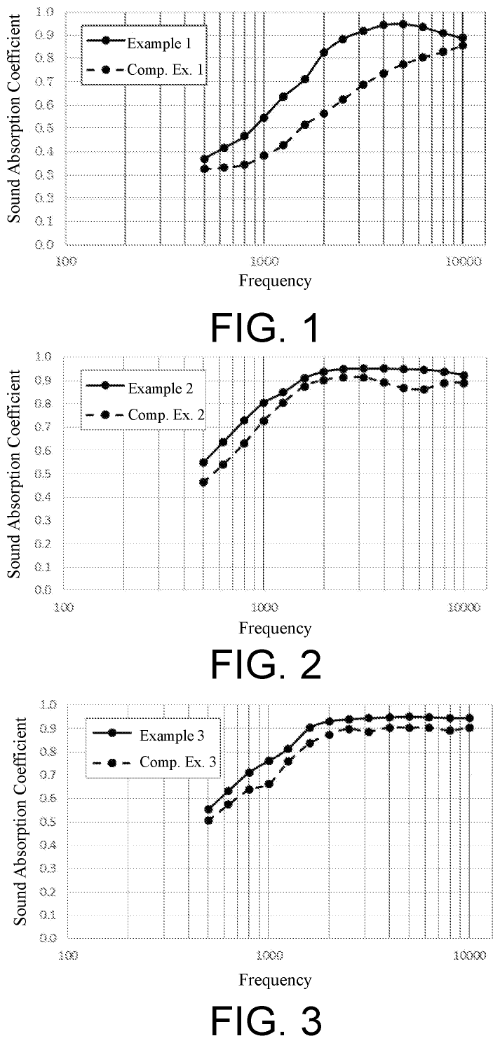

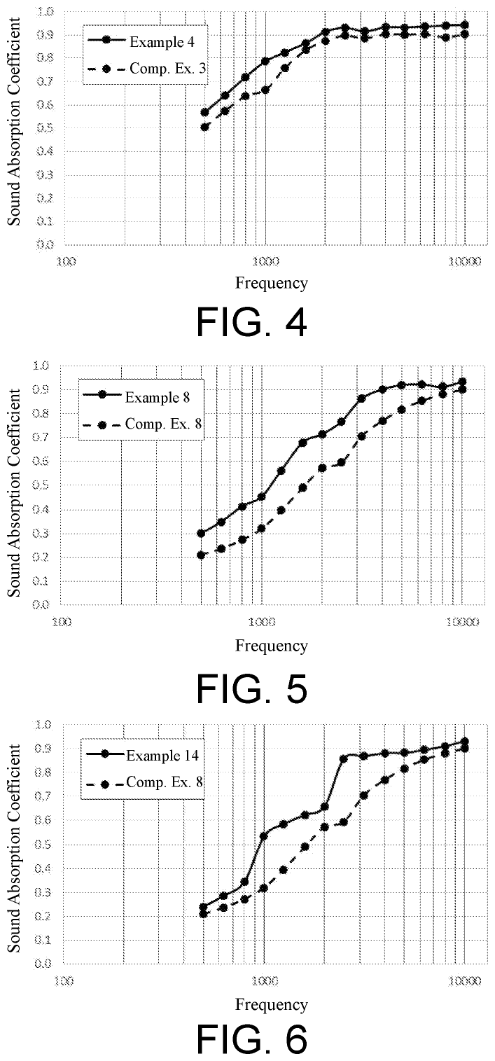

### EMBODIMENTS OF INVENTION

The present invention is described in detail below.

### Structure of Laminated Sound-Absorbing Material

A laminated sound-absorbing material of the present invention includes: at least one first layer, and at least one second layer that differs from the first layer. The first layer has a mean flow pore diameter of 2.0 to 60 μm and an air permeability according to the Frazier method of 30 to 200 cc/cm²·s. The second layer is a layer including at least one kind selected from the group consisting of a foamed resin, a nonwoven fabric and a woven fabric, has a thickness of 3 to 40 mm, and has a density that is lower than the first layer and is 51 to 150 kg/m³. The first layer is disposed on a sound incidence side of the second layer.

The laminated sound-absorbing material includes at least one first layer. Specifically, there can be one to two first layers. However, from a viewpoint of reducing a thickness of the sound-absorbing material, this is preferably one layer. The first layer may be made of one fiber aggregate or have a form wherein a plurality of fiber aggregates is stacked in one first layer. When the laminated sound-absorbing material includes two first layers, at least one first layer is disposed on the sound incidence side of the second layer. That is, it is sufficient for at least one first layer to be disposed on the sound incidence side of the second layer.

The laminated sound-absorbing material includes at least one second layer. Specifically, there can be one to two second layers. However, from a viewpoint of reducing the thickness of the sound-absorbing material, this is more preferably one layer. The second layer may be made of one foamed resin, nonwoven fabric, or woven fabric or have a form wherein a plurality of foamed resins, nonwoven fabrics, or woven fabrics is stacked in one second layer. When the laminated sound-absorbing material includes two second layers, at least one second layer is disposed on a sound transmission side of the first layer. That is, it is sufficient for at least one second layer to be disposed on the sound transmission side of the first layer.

As above, the laminated sound-absorbing material of the present invention preferably includes one first layer and one second layer. However, it may include two or more first layers and/or second layers. When two or more first layers and/or second layers are included, two or more different kinds of first layers or second layers may be included. Moreover, other configurations may be included as long as they do not compromise the effects of the present invention. For example, a protective layer, a layer made of fibers or a foam beyond the scope of the first layer and the second layer, a printing layer, a foam, a foil, a mesh, a woven fabric, or the like may be included. Moreover, an adhesive layer, a clip, stitching, or the like for connecting the layers may be included. Here, the protective layer is a substrate used when producing the first layer using electrospinning.

Each layer of the laminated sound-absorbing material may be—but does not have to be—physically and/or chemically adhered. A form may be adopted wherein a portion among a plurality of layers of the laminated sound-absorbing material is adhered and a portion is not adhered. Regarding this adhesion, the first layer and the second layer may be adhered by, for example, performing heating at a step of forming the first layer, which is a fiber layer, or at a step subsequent thereto to melt a portion of the fibers constituting the first layer and fusing the first layer onto the second layer, which is a porous layer. Moreover, it is also preferable to adhere the layers by applying an adhesive to a surface of the first layer or the second layer and stacking the layers.

The thickness of the laminated sound-absorbing material is not particularly limited as long as the effects of the present invention are obtained. However, it can be made to be, for example, 3 to 50 mm, and 3 to 40 mm is preferable. From a viewpoint of space savings, 3 to 30 mm is more preferable. Note that the thickness of the laminated sound-absorbing material typically signifies a total thickness of the first layer and the second layer. When an exterior member such as a cartridge or a lid is attached, a thickness thereof is not included.

An air permeability of the laminated sound-absorbing material is not particularly limited as long as a desired sound absorption performance is obtained. However, it can be made to be 5 to 500 cc/cm²·s, and 5 to 200 cc/cm²·s is preferable. The air permeability being 5 cc/cm²·s or higher prevents a sound absorption coefficient from being reduced due to sound being reflected at a surface of the sound-absorbing material, and the air permeability being 500 cc/cm²·s or lower reduces a tortuosity inside the sound-absorbing material and prevents energy reduction due to energy loss inside the sound-absorbing material.

In the laminated sound-absorbing material of the present invention, the density of the first layer is higher than the density of the second layer. Moreover, a layer having a relatively higher density (first layer) is disposed on a sound incidence side of a layer having a relatively lower density (second layer). Conventionally, a sound-absorbing material is expected to have both a sound absorption performance and a sound insulation performance, and it is believed that the greater a density thereof, the less likely it is for sound to pass through, making the material effective for sound insulation. In the laminated sound-absorbing material of the present invention, selecting a first layer having air permeability for a sound incidence side can guide sound into the sound-absorbing material, and selecting a first layer having a higher density can promote reflection from the second layer to the first layer. This is believed to further increase an effect of attenuating sound inside the sound-absorbing material and provide a higher sound absorbing property. As for adjusting the air permeability, by, for example, making the fibers constituting the first layer have a small diameter, a first layer (fiber layer) having a high density and low air permeability can be obtained. Moreover, the air permeability can also be adjusted by a method such as embossing or heating and pressurizing. Note that the air permeability can be measured by a known method. For example, it can be measured by the Frazier method.

### Configuration of Each Layer: First Layer

As the first layer included in the laminated sound-absorbing material of the present invention, a layer made of fibers whose average fiber diameter is 30 nm to 60 μm can be used. A layer made of fibers whose average fiber diameter is 50 nm to 50 μm is preferable. The average fiber diameter being 30 nm to 50 μm signifies that the average fiber diameter is within this numerical range. The average fiber diameter being within a range of 30 nm to 60 μm enables efficient and stable production of a first layer having a mean flow pore diameter and air permeability that provide a sound absorption effect by being combined with the second layer, which is detailed separately. Moreover, the fibers constituting the first layer may have a circular fiber cross section or a modified cross section. For example, modified-cross-section fibers whose fiber cross section is triangular, pentagonal, flat, star-shaped, or the like can also be used. Measurement of fiber diameters and calculation of the average fiber diameter can be performed by known methods. These are values obtained by, for example, measuring or calculating from an enlarged photograph of the surface of the layer. A specific measurement method is detailed in the examples.

For the first layer included in the laminated sound-absorbing material of the present invention, one first layer may be made from one fiber aggregate, or a plurality of fiber aggregates may be included in one first layer so stacked layers of fiber aggregates form one first layer. Note that in the present specification, a fiber aggregate signifies a fiber aggregate that is one continuous body. A grammage of the first layer is preferably 0.01 to 100 g/m² and more preferably 0.1 to 80 g/m². The grammage being 0.01 g/m² or more enables favorable control of a flow resistance due to the density difference between the first layer and the second layer, and the grammage being 100 g/m² or less provides excellent productivity of the sound-absorbing material. From a viewpoint of reducing the thickness of the sound-absorbing material, a thinner thickness is preferable for the first layer. Specifically, less than 0.5 mm is preferable, less than 0.2 mm is more preferable, less than 0.15 mm is further preferable, and less than 0.1 mm is particularly preferable.

The air permeability of the first layer is 30 to 200 cc/cm²·s and is preferably 30 to 150 cc/cm²·s. The air permeability is preferably 30 cc/cm²·s or more because this enables sound arising from a sound source to be introduced into the sound-absorbing material, thereby enabling efficient sound absorption, and the air permeability is preferably 200 cc/cm²·s or less because this enables sound-wave flow adjustment with the second layer positioned downstream from the sound source. Moreover, the mean flow pore diameter of the first layer can be made to be 2.0 to 60 μm, 2.0 to 50 μm being preferable. The mean flow pore diameter is preferably 2.0 82 m or more because this enables reflected waves to be suppressed and incorporation of sound into the sound-absorbing material, and the mean flow pore diameter is preferably 60 μm or less because this enables promotion of reflection, from the second layer to the first layer, of the sound waves incorporated into the sound-absorbing material due to the density difference in the configuration of the sound-absorbing material, thereby enabling increased internal sound-absorption efficiency.

The fiber aggregate constituting the first layer is preferably a nonwoven fabric and is not particularly limited. However, it is preferably a spunbonded nonwoven fabric, a melt-blown nonwoven fabric, a nonwoven fabric formed by electrospinning, or the like.

A resin constituting the first layer is not particularly limited as long as the effects of the invention are obtained. However, for example, a polyolefin resin; a polyurethane; polylactic acid; an acrylic resin; a polyester such as polyethylene terephthalate or polybutylene terephthalate; a nylon (amide resin) such as nylon 6, nylon 6,6, or nylon 1,2; polyphenylene sulfide; polyvinyl alcohol; polystyrene, a polysulfone; a liquid-crystal polymer; a polyethylene-vinyl acetate copolymer; polyacrylonitrile; polyvinylidene fluoride; and polyvinylidene fluoride-hexafluoropropylene can be mentioned. As the polyolefin resin, a, polyethylene resin and a polypropylene resin can be illustrated. As the polyethylene resin, low-density polyethylene (LDPE), high-density polyethylene (HDPE), linear low-density polyethylene (LLDPE), and the like can be mentioned, and as the polypropylene resin, a homopolymer of propylene, a copolymer polypropylene wherein propylene and another monomer such as ethylene or butane are polymerized, and the like can be mentioned. The fiber aggregate preferably includes one kind among the above resins but may include two or more kinds.

Furthermore, it is also preferable for the first layer to be a spunbonded nonwoven fabric that uses a flat yarn whose fiber cross-section shape is flat. Specifically, for example, a spunbonded nonwoven fabric that uses as the flat yarn a flat yarn that has a fineness of 0.01 to 20 dtex and is made of a polyolefin resin (polypropylene, polyethylene), polyethylene terephthalate, a nylon, or the like may be produced and used, or a commercially available product can be used. When using a commercially available product, for example, Eltas FLAT or Eltas Emboss (product names; made by Asahi Kasei) can be preferably used. It is thought that a spunbonded nonwoven fabric that uses a flat yarn can be preferably used in the laminated sound-absorbing material of the present invention because it has a low grammage, is thin, and is highly dense.

Furthermore, the fibers constituting the first layer may include various additives other than the resin. As additives that can be added to the resin, for example, a filler, a stabilizer, a plasticizer, an adhesive, an adhesion promoter (such as silane or a titanate), silica, glass, clay, talc, a pigment, a colorant, an antioxidant, a fluorescent whitening agent, an antibacterial agent, a surfactant, a flame retardant, and a fluoropolymer can be mentioned. One or more among the additives may be used to reduce a weight and/or cost of the obtained fibers and layer, adjust a viscosity, or modify thermal characteristics of the fibers. Alternatively, various physical characteristics and activities stemming from characteristics of the additives—which include electrical characteristics, optical characteristics, characteristics relating to density, and characteristics relating to a liquid barrier or adhesion—may be imparted.

### Configuration of Each Layer: Second Layer

The second layer (porous layer) in the laminated sound absorbing material of the present invention has a sound absorbing property and a function of keeping a shape of the entire sound absorbing material by supporting the first layer. The second layer may be made of a layer of one porous material, or one second layer may be formed by integrating a plurality of porous materials. When two or more layers of porous materials are consecutively disposed as one second layer, there is an advantage wherein the thickness of the layer is easy to control according to a thickness of the porous material. The second layer has a density lower than that of the first layer, is a layer formed of at least one selected from the group consisting of a foamed resin, a nonwoven fabric, and a woven fabric, and has a thickness of 3 to 40 mm and a density of 51 to 150 kg/m³. Note that in the present specification, a porous material includes a foamed resin, a nonwoven fabric, and a woven fabric and signifies a material exhibiting air permeability due to a large number of holes being present in the material.

When a member constituting the second layer is a nonwoven fabric or a woven fabric, this nonwoven fabric or woven fabric preferably includes: at least one kind of fibers selected from the group consisting of polyethylene terephthalate fibers, polybutylene terephthalate fibers, polyethylene fibers, polypropylene fibers, glass fibers, and natural fibers, or composite fibers wherein two or more kinds selected from the group consisting of polyethylene terephthalate, polybutylene terephthalate, polyethylene, polypropylene, glass, and a natural material are composited.

When the member constituting the second layer is a felt of a fiber material, a polyethylene terephthalate or other polyester fiber felt, a nylon fiber felt, a polyethylene fiber felt, a polypropylene fiber felt, an acrylic fiber felt, a silica-alumina ceramic fiber felt, a silica fiber felt (such as “Siltex” made by Nichias Corp.), cotton, sheep wool, wood wool, and kudzu fibers or the like made into a felt by a thermosetting resin (generic name: resin felt) can be mentioned. These are preferable in that they are easily obtained due to being commercially available.

Furthermore, when the member constituting the second layer is a foamed resin, the second layer is particularly preferably a layer formed of a urethane foamed resin or a melamine foamed resin. The laminated sound absorbing material may include a member of one kind and preferably includes members of two or more kinds. Since it is particularly preferable that these have air permeability, it is preferable to have open pores when the air permeability is low. The foamed resin is preferably a foamed resin having open cells (communicating pores).

As a resin constituting the above-described foamed resin, for example, a polyolefin-based resin, a polyurethane-based resin, and a melamine-based resin can be exemplified. As the polyolefin-based resin, a homopolymer of ethylene, propylene, butene-1, 4-methylpentene-1, or the like, a random or block copolymer of these with other α-olefins, that is, with one or more of ethylene, propylene, butene-1, pentene-1, hexene-1, 4-methylpentene-1, and the like, a copolymer obtained by combining them, or a mixture thereof can be exemplified.

A density of the second layer is 51 to 150 kg/m³ and preferably 51 to 135 kg/m³. When the density is 51 kg/m³ or more, it is preferable in terms of good moldability and being easily obtainable due to being available on the market generally, and when the density is 150 kg/m³ or less, it is preferable because it is lightweight as the sound absorbing material and has high workability during installation or the like.

In the present invention, the second layer preferably has a thickness of 3 mm or more. An upper limit of the thickness of the second layer is not particularly limited, but from the perspective of a space-saving property, it is preferably 3 to 60 mm and more preferably 3 to 40 mm. When the second layer is constituted by a plurality of porous materials, a thickness of each porous material constituting the second layer can be, for example, 20 μm to 60 mm and preferably 3 to 60 mm. When a thickness of the member is 20 μm or more, wrinkles do not occur, handling is easy, and the productivity is satisfactory, and when the thickness of the member is 60 mm or less, there is no likelihood of hindering the space-saving property.

The second layer is a thicker layer having a lower density than the first layer, and it is thought that such a structure reduces sound reflection and contributes to a sound absorbing property. Moreover, an air permeability of the second layer can be, for example, 10 cc/cm²·s or more. The air permeability of the second layer may be higher than, lower than, or equal to the air permeability of the first layer as long as the effects of the present invention are obtained.

Additives of various types such as, for example, a colorant, an antioxidant, a light stabilizer, an ultraviolet absorbing agent, a neutralizer, a nucleating agent, a lubricant, an antibacterial agent, a flame retardant, a plasticizer, other thermoplastic resins, and the like may be added to the second layer within a range not hindering the effects of the present invention. Also, a surface thereof may be treated with finishing agents of various kinds, and thereby functions such as water repellency, an antistatic property, surface smoothness, wear resistance, and the like may be imparted.

### Sound Absorption Characteristics of Laminated Sound-Absorbing Material

The laminated sound absorbing material of the present invention has a feature of having an excellent sound absorbing property particularly in a low-frequency range (frequency range of 500 to 1000 Hz), an intermediate-frequency range (frequency range of 1600 to 2500 Hz), and a high-frequency range (frequency range of 5000 to 10000 Hz). The laminated sound absorbing material of the present invention exhibits sound absorbing characteristics different from those of conventional sound absorbing materials in that the sound absorbing property is excellent particularly in the range of 500 Hz to 1000 Hz. Although not bound by a particular theory, it is thought that the laminated sound absorbing material of the present invention can obtain a small thickness and a performance of having excellent absorbency in the low-frequency range, the intermediate-frequency range, and the high-frequency range as a result of utilizing a density difference between the first layer and the second layer to control flow resistance of sound waves and utilizing transmission, reflection, and interference of the sound waves. Note that a method for evaluating the sound absorption property will be described in detail in examples.

In the laminated sound absorbing material of the present invention, it is preferable that a sound absorption coefficient by a vertical incidence sound absorption coefficient measuring method at the frequency of 500 to 1000 Hz be improved by 0.03 or more compared to a sound absorption coefficient of a case in which only one second layer included in the laminated sound absorbing material is present. Moreover, in the laminated sound absorbing material of the present invention, it is preferable that a sound absorption coefficient by a vertical incidence sound absorption coefficient measuring method at the frequency of 1,600 to 2,500 Hz be improved by 0.03 or more compared to a sound absorption coefficient of a case in which only one second layer included in the laminated sound absorbing material is present. Moreover, in the laminated sound absorbing material of the present invention, it is preferable that a sound absorption coefficient by a vertical incidence sound absorption coefficient measuring method at the frequency of 5,000 to 10,000 Hz be improved by 0.03 or more compared to a sound absorption coefficient of a case in which only one second layer included in the laminated sound absorbing material is present.

### Production Method of Laminated Sound-Absorbing Material

A production method of the laminated sound-absorbing material is not limited in particular. However, it can be obtained by, for example, a production method that includes a step of forming one first aggregate on one second layer. Note that in the step of forming the first layer, an additional layer (for example, a protective layer) other than the first layer can be further added and laminated.

A foamed resin, a nonwoven fabric, and/or a woven fabric used as the second layer may be manufactured by a known method and used, or a product available on the market may be selected and used.

When overlapping and integrating a plurality of laminates formed of two layers of the second layer/the first layer obtained as described above, a method thereof is not particularly limited and may be simple overlapping without performing adhesion, and adhesion methods of various types, that is, thereto-compression bonding with a heated flat roll or embossed roll, adhesion with a hot melt agent or a chemical adhesive, thermal adhesion with circulating hot air or radiant heat, and the like can also be employed. Of these, a heat treatment with circulating hot air or radiant heat is particularly preferable from the perspective of suppressing deterioration of physical properties of the first layer. In a case of the thereto-compression bonding with a flat roll or embossed roll, deterioration in performance such as deterioration of sound absorption characteristics is likely to occur and stable manufacture is likely to be difficult because of damage such as the first layer being melted to form a film and tearing occurring at a portion near an embossed point. Also, in a case of the adhesion with a hot melt agent or a chemical adhesive, spaces between fibers of the first layer may be filled with components thereof, and deterioration in performance is likely to occur. On the other hand, integration by the heat treatment with circulating hot air or radiant heat is preferable because damage to the first layer is small and integration can be performed with a sufficient delamination strength. In the case of integration by the heat treatment with circulating hot air or radiant heat, although not particularly limited, it is preferable to use a nonwoven fabric, a foamed resin, and a felt made of heat-fusible composite fibers.

### EXAMPLES

The present invention is described in greater detail below via examples. However, the following examples are merely for illustrative purposes. The scope of the present invention is not limited to the present examples.

Measurement methods and definitions of physical property values used in the examples are described below.

### Average Fiber Diameter

Fibers were observed using a scanning electron microscope SU8020 manufactured by Hitachi High-Technologies Corporation, and diameters of 50 fibers were measured using image analysis software. An average value of the fiber diameters of the 50 fibers was taken as an average fiber diameter.

### Sound Absorption Coefficient Measurement 1

After taking a sample with a diameter of 16.6 mm from the first layer and the second layer and laminating them under each condition, a vertical incidence sound absorption coefficient measurement when a plane sound wave was vertically incident on a test piece at a frequency of 400 to 10000 Hz was performed in accordance with ASTM E 1050 using a vertical incidence sound absorption coefficient measuring device “WinZac MTX manufactured by Nihon Onkyo Engineering Co., Ltd.”

### Sound Absorbing Property of Low-Frequency Range

A sound absorption coefficient was measured in one-third octave band of sound absorption of the obtained sample, and an improvement range was evaluated by a comparative evaluation with a sample without the first layer (that is, only the second layer). The vertical incidence sound absorption coefficient of each sample was measured in the ⅓ octave band, and an evaluation was performed by calculating a difference. When an improvement range of the sound absorbing performance in the frequency range of 500 to 1000 Hz is shown, it is determined that the improvement range of the sound absorbing property is high when the numerical value is high. When the values were 0.03 or more at all measurement points (specifically, 500 Hz, 630 Hz, 800 Hz, 1000 Hz), the improvement of the sound absorbing property in the low-frequency range was evaluated as satisfactory (◯), and when there was a measurement point less than 0.03, the improvement of the sound absorbing property was evaluated as poor (x).

### Sound Absorbing Property of Intermediate-Frequency Range

An evaluation of the sound absorbing property in the intermediate-frequency range was performed in the same manner as the sound absorbing property in the low-frequency range except that the frequency range was changed to 1600 to 2500 Hz, and calculation of the improvement range was performed at 1600 Hz, 2000 Hz, and 2500 Hz.

### Sound Absorbing Property of High-Frequency Range

An evaluation of the sound absorbing property in the high-frequency range was performed in the same manner as the sound absorbing property in the low-frequency range except that the frequency range was changed to 5000 to 10000 Hz, and calculation of the improvement range was performed at 5000 Hz, 6300 Hz, 8000 Hz, and 10000 Hz.

### Air Permeability

An air permeability was measured by a woven fabric air permeability tester (Frazier method) manufactured by Toyo Seiki Seisaku-sho Ltd. in accordance with JIS L1913.

### Thickness

An air permeability was measured by Digi-Thickness Tester manufactured by Toyo Seiki Seisaku-sho Ltd. in accordance with HS K6767 at a pressure of 3.5 g/cm² of 35 mm.

### Mean Flow Pore Diameter

A mean flow pore diameter was measured (JIS K 3822) using Capillary Flow Porometer (CEP-1200-A, commercially available from POROUS MATERIAL).

### Preparation of Protective Layer

As a protective layer, a commercially available card method through-air nonwoven fabric (with a basis weight of 18 g/m² and a thickness of 60 μm)) made of polyethylene terephthalate was prepared.

### Preparation of First Layer (Fiber Layer)

[Fiber Layers A, B, C] (Electrospun Nonwoven Fabric)

Kynar (product name) 3120, which is polyvinylidene fluoride-hexafluoropropylene (hereinafter abbreviated as “PVDF”) produced by Arkema, was dissolved in a co-solvent of N,N-dimethylacetamide and acetone (60/40 (w/w)) at a concentration of 15% by mass to prepare an electrospinning solution, and 0.01% by mass of sodium lauryl sulfate was added. The PVDF solution was electrospun on the protective layer to prepare a fiber laminate formed of two layers of the protective layer and PVDF ultrafine fibers. Conditions for the electrospinning were that, in terms of a needle gauge, a 24 G needle was used, a single-hole solution supply amount was 3.0 mL/h, an applied voltage was 35 kV, and a spinning distance was 17.5 cm.

For the PVDF ultrafine fibers in the fiber laminate, a basis weight of the layer was 0.2 g/m², an average fiber diameter was 80 nm, and a melting temperature was 168° C. This was defined as a fiber layer A. An average flow rate pore diameter thereof was evaluated to be 5.8 μm, and an air permeability by the Frazier method was 47 cc/cm²·s.

Also, a transfer speed of the protective layer was changed so that the basis weight was adjusted to 0.4 g/m². An average fiber diameter of the obtained fiber layer was 80 nm, and the melting temperature was 168° C. This was defined as a fiber layer B. An average flow rate pore diameter thereof was evaluated to be 2.1 μm, and an air permeability by the Frazier method was 31 cc/cm²·s.

Further, the basis weight was adjusted to 3.0 g/m². At this time, the average fiber diameter was 80 nm and the melting temperature was 168° C. This was defined as a fiber layer C. An average flow rate pore diameter was evaluated to be 0.7 μm, and an air permeability by the Frazier method was 0.7 cc/cm²·s.

[Fiber Layers D, E] (Spunbonded Nonwoven Fabric)

ELTAS (registered trademark) FLAT EH5025 made by Asahi Kasei, a commercially available nonwoven-fabric material (0.11 mm thick) was defined as a fiber layer D, and EH5035 (0.14 mm thick) was defined as a fiber layer E. Note that the fiber layers D, E are spunbonded nonwoven fabrics made of a flat yarn. The flat yarn is a fiber having a fiber diameter of an ellipsis major-axis diameter of 40 μm and a minor-axis diameter of 5 μm. The fiber layer D had an average flow rate pore diameter of 41 μm and an air permeability of 138 cc/cm²·s by the Frazier method. The fiber layer E had an average flow rate pore diameter of 28 μm and an air permeability of 70 cc/cm²·s by the Frazier method.

### Preparation of Second Layer (Porous Layer)

[Porous Layers α, β, γ, δ, ζ] (Needled Felt)

A needled felt made by Nittoh Supply (density of 80 kg/m³, thickness of 10 mm), a commercially available felt material, was defined as a porous layer α. Two porous layers α stacked together for a 20 mm thickness was defined as a porous layer β. Three porous layers α stacked together and heated and compressed for 10 minutes at 4 MPa and 60° C. in a Mini Test Press made by Toyo Seiki for a 2.5 mm thickness was defined as a porous layer γ. A density of the porous layer γwas 96 kg/m³. Four porous layers a stacked together and heated and compressed for 10 minutes at 6 MPa and 70° C. in a Mini Test Press made by Toyo Seiki for a 25 mm thickness was defined as a porous layer δ. A density of the porous layer δ was 128 kg/m³. Five porous layers a stacked together and heated and compressed for 10 minutes at 7 MPa and 75° C. in a Mini Test Press made by Toyo Seiki for a 25 mm thickness was defined as a porous layer ζ. A density of the porous layer ζ was 160 kg/m³.

An air permeability by the Frazier method was 42 cc/cm²·s for the porous layer α, 22 cc/cm²·s for the porous layer β, 18 cc/cm²·s for the porous layer γ, 10 cc/cm²·s for the porous layer δ, and 3 cc/cm²·s for the porous layer ζ.

[Porous Layers η, θ, κ, λ, μ, ν, ρ, σ, τ, φ] (Airlaid Nonwoven Fabric)

A sheath-core type thermally fusible composite fiber in which a sheath component with a fiber diameter of 16 μm was made of a high-density polyethylene resin and a core component was made of a polypropylene resin was prepared by a heat-melt spinning method using high-density polyethylene “M6900” (MFR 17 g/10 minutes) manufactured by KEIYO Polyethylene Co., Ltd. as the high-density polyethylene resin, and a polypropylene homopolymer “SA3A” (MFR=11 g/10 minutes) manufactured by Japan Polypropylene Corporation as the polypropylene resin. Using the obtained sheath-core type thermally fusible composite fiber, a card method through-air nonwoven fabric having a basis weight of 200 g/m², a thickness of 5 min, and a width of 1000 mm was prepared. The card method through-air nonwoven fabric was crushed to about 5 mm using a uniaxial crusher (ES3280) manufactured by Shoken Co., Ltd. This crushed nonwoven fabric was made into a web in an air-laid tester, and this web was heated at a set temperature of 142° C. to obtain a porous layer η having a basis weight of 400 g/m² and a thickness of 5 mm and a porous layer θ having a basis weight of 800 g/m² and a thickness of 10 mm. The porous layer θ had a density of 80 kg/m³ and an air permeability of 63 cc/cm²·s. A porous layer κ, which is two porous layers θ stacked together for a thickness of 20 mm, had an air permeability of 46 cc/cm².s. A porous layer λ, which is two porous layers θ and one η stacked together for a thickness of 25 mm, had an air permeability of 41 cc/cm²·s. A porous layer μ, which is three porous layers η stacked together and heated and compressed for 10 minutes at 3 MPa and 80° C. in a Mini Test Press made by Toyo Seiki for a 10 mm thickness had an air permeability of 36 cc/cm²·s. A porous layer ν, which is six porous layers η stacked together and heated and compressed for 10 minutes at 3 MPa and 80° C. in a Mini Test Press made by Toyo Seiki for a 20 mm thickness had an air permeability of 23 cc/cm²·s. A porous layer ρ, which is eight porous layers η stacked together and heated and compressed for 10 minutes at 4 MPa and 80° C. in a Mini Test Press made by Toyo Seiki for a 25 mm thickness had an air permeability of 15 cc/cm²·s.

A porous layer σ, which is four porous layers η stacked together and heated and compressed for 10 minutes at 5 MPa and 80° C. in a Mini Test Press made by Toyo Seiki for a 10 mm thickness had an air permeability of 32 cc/cm²·s. A porous layer τ, which is eight porous layers η stacked together and heated and compressed for 10 minutes at 5 MPa and 80° C. in a Mini Test Press made by Toyo Seiki for a 20 mm thickness had an air permeability of 14 cc/cm²·s. A porous layer φ, which is ten porous layers η stacked together and heated and compressed for 10 minutes at 5 MPa and 80° C. in a Mini Test Press made by Toyo Seiki for a 25 mm thickness had an air permeability of 12 cc/cm²·s.

### Example 1

Using the fiber layer A as the first layer and the porous layer α as the second layer, these were overlapped to form the fiber layer A/the porous layer α, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of a sample in which the fiber layer A was not present (Comparative Example 1) was taken, and an improvement range was calculated. The improvement range was 0.044 or more in the low-frequency range, 0.196 or more in the intermediate-frequency range, and 0.035 or more in the high-frequency range, and these were satisfactory.

### Example 2

Using the fiber layer A as the first layer and the porous layer β as the second layer, these were overlapped to form the fiber layer A/the porous layer β, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 2 was taken, and an improvement range was calculated. The improvement range was 0.079 or more in the low-frequency range, 0.036 or more in the intermediate-frequency range, and 0.034 or more in the high-frequency range, and these were satisfactory.

### Example 3

Using the fiber layer A as the first layer and the porous layer γ as the second layer, these were overlapped to form the fiber layer A/the porous layer γ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 3 was taken, and an improvement range was calculated. The improvement range was 0.047 or more in the low-frequency range, 0.041 or more in the intermediate-frequency range, and 0.040 or more in the high-frequency range, and these were satisfactory.

### Example 4

Using the fiber layer D as the first layer and the porous layer γ as the second layer, these were overlapped to form the fiber layer D/the porous layer γ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 3 was taken, and an improvement range was calculated. The improvement range was 0.063 or more in the low-frequency range. 0.030 or more in the intermediate-frequency range, and 0.031 or more in the high-frequency range, and these were satisfactory.

### Example 5

Using the fiber layer E as the first layer and the porous layer γ as the second layer, these were overlapped to form the fiber layer E/the porous layer γ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 3 was taken, and an improvement range was calculated. The improvement range was 0.085 or more in the low-frequency range, 0.030 or more in the intermediate-frequency range, and 0.033 or more in the high-frequency range, and these were satisfactory.

### Example 6

Using the fiber layer A as the first layer and the porous layer δ as the second layer, these were overlapped to form the fiber layer A/the porous layer δ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 4 was taken, and an improvement range was calculated. The improvement range was 0.031 or more in the low-frequency range, 0.030 or more in the intermediate-frequency range, and 0.030 or more in the high-frequency range, and these were satisfactory.

### Example 7

Using the fiber layer B as the first layer and the porous layer γ as the second layer, these were overlapped to form the fiber layer B/the porous layer γ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 3 was taken, and an improvement range was calculated. The improvement range was 0.038 or more in the low-frequency range, 0.044 or more in the intermediate-frequency range, and 0.032 or more in the high-frequency range, and these were satisfactory.

### Comparative Example 1

Only the porous layer α (thickness 10 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 2

Only the porous layer β (thickness 20 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 3

Only the porous layer γ (thickness 25 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 4

Only the porous layer δ (thickness 2.5 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 5

Only the porous layer ζ (thickness 25 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 6

Using the fiber layer A as the first layer and the porous layer ζ as the second layer, these were overlapped to form the fiber layer A/the porous layer ζ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. When a difference of the sound absorption coefficient compared to that of Comparative Example 1 was taken and an improvement range was calculated, the improvement range was 0.005 or more in the low-frequency range and 0.004 or more in the intermediate-frequency range, and no improvement effect was seen in the high-frequency range, and these were poor.

### Comparative Example 7

Using the fiber layer C as the first layer and the porous layer γ as the second layer, these were overlapped to form the fiber layer C/the porous layer γ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. When a difference of the sound absorption coefficient compared to that of Comparative Example 3 was taken and an improvement range was calculated, no improvement effect was seen in the low-frequency range, the intermediate-frequency region, and the high-frequency range, and these were poor.

The configurations of Examples 1 to 7 are summarized in Table 1, and the configurations of Comparative Examples (as “Comp. Ex.”) 1 to 7 are summarized in Table 2. The sound absorption coefficients of Examples 1 to 7 are summarized in Table 3, the sound absorption coefficients of Comparative Examples 1 to 7 are summarized in Table 4, and the improvement ranges of the sound absorption coefficient are summarized in Tables 5 and 6.

TABLE 1

| | Example | | | | | | |
|---|---|---|---|---|---|---|---|
| Configuration | 1 | 2 | 3 | 4 | 5 | 6 | 7 |
| First layer (fiber layer) | A | A | A | D | E | A | B |
| Fiber material | PVDF | PVDF | PVDF | PP | PP | PVDF | PVDF |
| Fiber diameter (μm) | 0.08 | 0.08 | 0.08 | 5 × 40 | 5 × 40 | 0.08 | 0.08 |
| Grammage (g/m²) | 0.2 | 0.2 | 0.2 | | 35 | 0.2 | 0.4 |
| Density (kg/m³) | 200 | 200 | 200 | 227 | 250 | 200 | 200 |
| Thickness (mm) | 0.001 | 0.001 | 0.001 | 0.11 | 0.14 | 0.001 | 0.002 |
| Air permeability (cc/m² · s) | 47 | 47 | 47 | 1.38 | 70 | 47 | 31 |
| Average flow rate pore diameter (μm) | 5.8 | 5.8 | 5.8 | 41 | 28 | 5.8 | 2.1 |
| Second layer (porous layer) | α | β | γ | γ | γ | δ | γ |
| Material | Felt | Felt | Felt | Felt | Felt | Felt | Felt |
| Density (kg/m³) | 80 | 80 | 96 | 96 | 96 | 128 | 96 |
| Thickness (mm) | 10 | 20 | 25 | 25 | 25 | 25 | 25 |
| Air permeability (cc/cm² · s) | 42 | 22 | 18 | 18 | 18 | 10 | 18 |

TABLE 2

| | Comp. Ex. | | | | | | |
|---|---|---|---|---|---|---|---|
| Configuration | 1 | 2 | 3 | 4 | 5 | 6 | 7 |
| First layer (fiber layer) | — | — | — | — | — | A | C |
| Fiber material | — | — | — | — | — | PVDF | PVDF |
| Fiber diameter (μm) | — | — | — | — | — | 0.08 | 0.08 |
| Grammage (g/m²) | — | — | — | — | — | 0.2 | 3 |
| Density (kg/m³) | — | — | — | — | — | 200 | 200 |
| Thickness (mm) | — | — | — | — | — | 0.001 | 0.014 |
| Air permeability (cc/cm² · s) | — | — | — | — | — | 47 | 0.7 |
| Average flow rate pore diameter (μm) | — | — | — | — | — | 5.8 | 0.7 |
| Second layer (porous layer) | α | β | γ | δ | ζ | ζ | γ |
| Material | Felt | Felt | Felt | Felt | Felt | Felt | Felt |
| Density (kg/m³) | 80 | 80 | 96 | 128 | 160 | 160 | 96 |
| Thickness (mm) | 10 | 20 | 25 | 25 | 25 | 25 | 25 |
| Air permeability (cc/cm² · s) | 42 | 22 | 18 | 10 | 3 | 3 | 18 |

TABLE 3

| Vertical-incidence | | | | | | | |
|---|---|---|---|---|---|---|---|
| sound absorption | Example | | | | | | |
| coefficient | 1 | 2 | 3 | 4 | 5 | 6 | 7 |
| 500 Hz | 0.370 | 0.549 | 0.553 | 0.569 | 0.593 | 0.690 | 0.544 |
| 630 Hz | 0.417 | 0.636 | 0.633 | 0.641 | 0.664 | 0.734 | 0.615 |
| 800 Hz | 0.467 | 0.728 | 0.711 | 0.719 | 0.723 | 0.780 | 0.700 |
| 1000 Hz | 0.547 | 0.804 | 0.761 | 0.786 | 0.763 | 0.815 | 0.790 |
| 1600 Hz | 0.711 | 0.910 | 0.903 | 0.865 | 0.880 | 0.865 | 0.909 |
| 2000 Hz | 0.824 | 0.937 | 0.930 | 0.914 | 0.923 | 0.886 | 0.943 |
| 2500 Hz | 0.884 | 0.949 | 0.939 | 0.931 | 0.928 | 0.940 | 0.942 |
| 5000 Hz | 0.950 | 0.948 | 0.950 | 0.933 | 0.935 | 0.957 | 0.935 |
| 6300 Hz | 0.936 | 0.946 | 0.948 | 0.937 | 0.943 | 0.973 | 0.937 |
| 8000 Hz | 0.910 | 0.937 | 0.945 | 0.941 | 0.947 | 0.977 | 0.931 |
| 10000 Hz | 0.889 | 0.923 | 0.944 | 0.943 | 0.948 | 0.987 | 0.936 |

TABLE 4

| Vertical-incidence | | | | | | | |
|---|---|---|---|---|---|---|---|
| sound absorption | Comp. Ex. | | | | | | |
| coefficient | 1 | 2 | 3 | 4 | 5 | 6 | 7 |
| 500 Hz | 0.326 | 0.464 | 0.506 | 0.646 | 0.654 | 0.659 | 0.452 |
| 630 Hz | 0.332 | 0.541 | 0.574 | 0.702 | 0.700 | 0.705 | 0.499 |
| 800 Hz | 0.345 | 0.630 | 0.638 | 0.749 | 0.737 | 0.743 | 0.628 |
| 1000 Hz | 0.383 | 0.725 | 0.663 | 0.782 | 0.767 | 0.773 | 0.829 |
| 1600 Hz | 0.515 | 0.874 | 0.835 | 0.835 | 0.827 | 0.831 | 0.866 |
| 2000 Hz | 0.566 | 0.901 | 0.874 | 0.852 | 0.856 | 0.865 | 0.857 |
| 2500 Hz | 0.624 | 0.911 | 0.898 | 0.909 | 0.880 | 0.891 | 0.831 |
| 5000 Hz | 0.775 | 0.867 | 0.902 | 0.927 | 0.940 | 0.952 | 0.690 |
| 6300 Hz | 0.803 | 0.862 | 0.903 | 0.943 | 0.948 | 0.945 | 0.656 |
| 8000 Hz | 0.828 | 0.889 | 0.890 | 0.941 | 0.950 | 0.946 | 0.630 |
| 10000 Hz | 0.854 | 0.889 | 0.904 | 0.940 | 0.947 | 0.936 | 0.612 |

TABLE 5

| Sound absorption | | | | | | | |
|---|---|---|---|---|---|---|---|
| coefficient | Example | | | | | | |
| improvement range | 1 | 2 | 3 | 4 | 5 | 6 | 7 |
| 500 Hz | 0.044 | 0.085 | 0.047 | 0.063 | 0.087 | 0.044 | 0.038 |
| 630 Hz | 0.085 | 0.095 | 0.059 | 0.067 | 0.090 | 0.032 | 0.041 |
| 800 Hz | 0.122 | 0.098 | 0.073 | 0.081 | 0.085 | 0.031 | 0.062 |
| 1000 Hz | 0.164 | 0.079 | 0.098 | 0.123 | 0.100 | 0.033 | 0.127 |
| Low-frequency range | ◯ | ◯ | ◯ | ◯ | ◯ | ◯ | ◯ |
| evaluation | | | | | | | |
| 1600 Hz | 0.196 | 0.036 | 0.068 | 0.030 | 0.045 | 0.030 | 0.074 |
| 2000 Hz | 0.258 | 0.036 | 0.056 | 0.040 | 0.049 | 0.034 | 0.069 |
| 2500 Hz | 0.260 | 0.038 | 0.041 | 0.033 | 0.030 | 0.031 | 0.044 |
| Intermediate-frequency | ◯ | ◯ | ◯ | ◯ | ◯ | ◯ | ◯ |
| range evaluation | | | | | | | |
| 5000 Hz | 0.175 | 0.081 | 0.048 | 0.031 | 0.033 | 0.030 | 0.033 |
| 6300 Hz | 0.133 | 0.084 | 0.045 | 0.034 | 0.040 | 0.030 | 0.034 |
| 8000 Hz | 0.082 | 0.048 | 0.055 | 0.051 | 0.057 | 0.036 | 0.041 |
| 10000 Hz | 0.035 | 0.034 | 0.040 | 0.039 | 0.044 | 0.047 | 0.032 |
| High-frequency range | ◯ | ◯ | ◯ | ◯ | ◯ | ◯ | ◯ |
| evaluation | | | | | | | |

TABLE 6

| Sound absorption | | | | | | | |
|---|---|---|---|---|---|---|---|
| coefficient | Comp. Ex. | | | | | | |
| improvement range | 1 | 2 | 3 | 4 | 5 | 6 | 7 |
| 500 Hz | — | — | — | — | — | 0.005 | −0.054 |
| 630 Hz | — | — | — | — | — | 0.005 | −0.075 |
| 800 Hz | — | — | — | — | — | 0.006 | −0.010 |
| 1000 Hz | — | — | — | — | — | 0.006 | 0.166 |
| Low-frequency range | | | | | | X | X |
| evaluation | | | | | | | |
| 1600 Hz | — | — | — | — | — | 0.004 | 0.031 |
| 2000 Hz | — | — | — | — | — | 0.009 | −0.017 |
| 2500 Hz | — | — | — | — | — | 0.011 | −0.067 |
| Intermediate-frequency | | | | | | X | X |
| range evaluation | | | | | | | |
| 5000 Hz | — | — | — | — | — | 0.012 | −0.212 |
| 6300 Hz | — | — | — | — | — | −0.003 | −0.247 |
| 8000 Hz | — | — | — | — | — | −0.004 | −0.260 |
| 10000 Hz | — | — | — | — | — | −0.011 | −0.292 |
| High-frequency range | | | | | | X | X |
| evaluation | | | | | | | |

### Example 8

Using the fiber layer A as the first layer and the porous layer θ as the second layer, these were overlapped to form the fiber layer A/the porous layer θ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 8 was taken, and an improvement range was calculated. The improvement range was 0.090 or more in the low-frequency range, 0.142 or more in the intermediate-frequency range, and 0.031 or more in the high-frequency range, and these were satisfactory.

### Example 9

Using the fiber layer A as the first layer and the porous layer κ as the second layer, these were overlapped to form the fiber layer A/the porous layer κ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 9 was taken, and an improvement range was calculated. The improvement range was 0.081 or more in the low-frequency range, 0.039 or more in the intermediate-frequency range, and 0.030 or more in the high-frequency range, and these were satisfactory.

### Example 10

Using the fiber layer A as the first layer and the porous layer λ as the second layer, these were overlapped to form the fiber layer A/the porous layer λ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 10 was taken, and an improvement range was calculated. The improvement range was 0.050 or more in the low-frequency range, 0.031 or more in the intermediate-frequency range, and 0.030 or more in the high-frequency range, and these were satisfactory.

### Example 11

Using the fiber layer A as the first layer and the porous layer μ as the second layer, these were overlapped to form the fiber layer A/the porous layer μ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 11 was taken, and an improvement range was calculated. The improvement range was 0.033 or more in the low-frequency range, 0.067 or more in the intermediate-frequency range, and 0.030 or more in the high-frequency range, and these were satisfactory.

### Example 12

Using the fiber layer A as the first layer and the porous layer ν as the second layer, these were overlapped to form the fiber layer A/the porous layer ν, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 12 was taken, and an improvement range was calculated. The improvement range was 0.044 or more in the low-frequency range, 0.030 or more in the intermediate-frequency range, and 0.030 or more in the high-frequency range, and these were satisfactory.

### Example 13

Using the fiber layer A as the first layer and the porous layer ρ as the second layer, these were overlapped to form the fiber layer A/the porous layer ρ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 13 was taken, and an improvement range was calculated. The improvement range was 0.034 or more in the low-frequency range, 0.030 or more in the intermediate-frequency range, and 0.032 or more in the high-frequency range, and these were satisfactory.

### Example 14

Using the fiber layer D as the first layer and the porous layer θ as the second layer, these were overlapped to form the fiber layer D/the porous layer θ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 8 was taken, and an improvement range was calculated. The improvement range was 0.030 or more in the low-frequency range, 0.087 or more in the intermediate-frequency range, and 0.030 or more in the high-frequency range, and these were satisfactory.

### Comparative Example 8

Only the porous layer θ (thickness 10 mm), which is the second layer, was cut out into a circle having a diameter of 16.6 mm to prepare a sample for sound absorption coefficient measurement. A sound absorption coefficient was measured in the low frequency range, the intermediate-frequency range, and the high-frequency range, and these were made to be the standard.

### Comparative Example 9

Only the porous layer κ (thickness 2.0 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 10

Only the porous layer λ (thickness 25 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 11

Only the porous layer μ (thickness 10 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to he the standard.

### Comparative Example 12

Only the porous layer ν (thickness 20 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 13

Only the porous layer ρ (thickness 2.5 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 14

Only the porous layer σ (thickness 10 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 15

Only the porous layer τ (thickness 20 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 16

Only the porous layer φ (thickness 25 mm), which is the second layer, was cut out into a circle having a diameter of 16.6 mm to prepare a sample for sound absorption coefficient measurement. A sound absorption coefficient was measured in the low-frequency range, the intermediate-frequency range, and the high-frequency range, and these were made to be the standard.

### Comparative Example 17

Using the fiber layer A as the first layer and the porous layer a as the second layer, these were overlapped to form the fiber layer A/the porous layer σ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 14 was taken, and an improvement range was calculated The improvement range was 0.030 or more in the intermediate-frequency range, and this was satisfactory. However, the improvement range was 0.028 or more in the low-frequency range, and no tendency toward improvement was seen in the high-frequency range, and these were poor.

### Comparative Example 18

Using the fiber layer A as the first layer and the porous layer τ as the second layer, these were overlapped to form the fiber layer A/the porous layer τ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 15 was taken, and an improvement range was calculated. No tendency toward improvement was seen for the improvement range in the low-frequency range, the intermediate-frequency range, and the high-frequency range, and these were poor.

### Comparative Example 19

Using the fiber layer A as the first layer and the porous layer φ as the second layer, these were overlapped to form the fiber layer A/the porous layer φ, which was cut out into a circle having a diameter of 16.6 mm to prepare a sample for sound absorption coefficient measurement. A sound absorption coefficient thereof was measured in the low-frequency range, the intermediate-frequency range, and the high-frequency range. A difference of the sound absorption coefficient compared to that of Comparative Example 16 was taken, and an improvement range was calculated. No tendency toward improvement was seen for the improvement range in the low-frequency range, the intermediate-frequency range, and the high-frequency range, and these were poor.

Examples 8 to 14 have their configurations summarized in Table 7, sound absorption coefficients summarized in Table 8, and improvement ranges of the sound absorption coefficient summarized in Table 9. Comparative Examples (as “Comp. Ex.”) 8-19 have their configurations summarized in Table 10, sound absorption coefficients summarized in Table 11, and improvement ranges of the sound absorption coefficient summarized in Table 12.

TABLE 7

| | Example | | | | | | |
|---|---|---|---|---|---|---|---|
| Configuration | 8 | 9 | 10 | 11 | 12 | 13 | 14 |
| First layer (fiber layer) | A | A | A | A | A | A | D |
| Fiber material | PVDF | PVDF | PVDF | PVDF | PVDF | PVDF | PP |
| Fiber diameter (μm) | 0.08 | 0.08 | 0.08 | 0.08 | 0.08 | 0.08 | 5 × 40 |
| Grammage (g/m²) | 0.2 | 0.2 | 0.2 | 0.2 | 0.2 | 0.2 | 25 |
| Density (kg/m³) | 200 | 200 | 200 | 200 | 200 | 200 | 227 |
| Thickness (mm) | 0.001 | 0.001 | 0.001 | 0.001 | 0.001 | 0.001 | 0.11 |
| Air permeability (cc/cm² · s) | 47 | 47 | 47 | 47 | 47 | 47 | 138 |
| Average flow rate pore diameter (μm) | 5.8 | 5.8 | 5.8 | 5.8 | 5.8 | 5.8 | 41 |
| Second layer (porous layer) | θ | κ | λ | μ | ν | ρ | θ |
| Material | AL | AL | AL | AL | AL | AL | AL |
| Density (kg/m³⁾ | 80 | 80 | 80 | 120 | 120 | 128 | 80 |
| Thickness (mm) | 10 | 20 | 25 | 10 | 20 | 25 | 10 |
| Air permeability (cc/cm² · s) | 63 | 46 | 41 | 36 | 23 | 15 | 63 |

* AL: Air-laid

TABLE 8

| Vert.-incidence sound | Example | | | | | | |
|---|---|---|---|---|---|---|---|
| absorption coefficient | 8 | 9 | 10 | 11 | 12 | 13 | 14 |
| 500 Hz | 0.301 | 0.608 | 0.564 | 0.234 | 0.546 | 0.607 | 0.241 |
| 630 Hz | 0.349 | 0.683 | 0.662 | 0.283 | 0.589 | 0.649 | 0.287 |
| 800 Hz | 0.413 | 0.752 | 0.757 | 0.349 | 0.668 | 0.799 | 0.345 |
| 1000 Hz | 0.454 | 0.807 | 0.824 | 0.418 | 0.804 | 0.855 | 0.534 |
| 1600 Hz | 0.679 | 0.874 | 0.908 | 0.675 | 0.900 | 0.885 | 0.624 |
| 2000 Hz | 0.714 | 0.938 | 0.944 | 0.767 | 0.915 | 0.894 | 0.659 |
| 2500 Hz | 0.767 | 0.949 | 0.950 | 0.842 | 0.926 | 0.899 | 0.858 |
| 5000 Hz | 0.919 | 0.944 | 0.950 | 0.946 | 0.936 | 0.945 | 0.882 |
| 6300 Hz | 0.921 | 0.947 | 0.948 | 0.951 | 0.943 | 0.942 | 0.895 |
| 8000 Hz | 0.911 | 0.946 | 0.941 | 0.949 | 0.945 | 0.948 | 0.910 |
| 10000 Hz | 0.932 | 0.937 | 0.935 | 0.948 | 0.944 | 0.950 | 0.931 |

TABLE 9

| | Comp. Ex. | | | | | | | | | | | |
|---|---|---|---|---|---|---|---|---|---|---|---|---|
| Configuration | 8 | 9 | 10 | 11 | 12 | 13 | 14 | 15 | 16 | 17 | 18 | 19 |
| First layer (fiber layer) | — | — | — | — | — | — | — | — | — | A | A | A |
| Fiber material | — | — | — | — | — | — | — | — | — | PVDF | PVDF | PVDF |
| Fiber diameter (μm) | — | — | — | — | — | — | — | — | — | 0.08 | 0.08 | 0.08 |
| Grammage (g/m²) | — | — | — | — | — | — | — | — | — | 0.2 | 0.2 | 0.2 |
| Density (kg/m³) | — | — | — | — | — | — | — | — | — | 200 | 200 | 200 |
| Thickness (mm) | — | — | — | — | — | — | — | — | — | 0.001 | 0.001 | 0.001 |
| Air permeability (cc/cm² · s) | — | — | — | — | — | — | — | — | — | 47 | 47 | 47 |
| Average flow rate pore diameter (μm) | — | — | — | — | — | — | — | — | — | 5.8 | 5.8 | 5.8 |
| Second layer (porous layer) | θ | κ | λ | μ | ν | ρ | σ | τ | ϕ | σ | τ | ϕ |
| Material | AL | AL | AL | AL | AL | AL | AL | AL | AL | AL | AL | AL |
| Density (kg/m³) | 80 | 80 | 80 | 120 | 120 | 128 | 160 | 160 | 160 | 160 | 160 | 160 |
| Thickness (mm) | 10 | 20 | 25 | 10 | 20 | 25 | 10 | 20 | 25 | 10 | 20 | 25 |
| Air permeability (cc/cm² · s) | 63 | 46 | 41 | 36 | 23 | 15 | 32 | 14 | 12 | 32 | 14 | 12 |

* AL: Air-laid

TABLE 10

| Vertical-incidence | | | | | | | | | | | | |
|---|---|---|---|---|---|---|---|---|---|---|---|---|
| sound absorption | Comp. Ex. | | | | | | | | | | | |
| coefficient | 8 | 9 | 10 | 11 | 12 | 13 | 14 | 15 | 16 | 17 | 18 | 19 |
| 500 Hz | 0.211 | 0.527 | 0.514 | 0.201 | 0.457 | 0.563 | 0.275 | 0.619 | 0.642 | 0.303 | 0.612 | 0.655 |
| 630 Hz | 0.236 | 0.595 | 0.601 | 0.238 | 0.545 | 0.609 | 0.327 | 0.686 | 0.701 | 0.364 | 0.678 | 0.710 |
| 800 Hz | 0.273 | 0.663 | 0.688 | 0.292 | 0.615 | 0.765 | 0.398 | 0.739 | 0.743 | 0.444 | 0.729 | 0.747 |
| 1000 Hz | 0.320 | 0.725 | 0.763 | 0.359 | 0.703 | 0.817 | 0.480 | 0.769 | 0.767 | 0.533 | 0.760 | 0.769 |
| 1600 Hz | 0.491 | 0.822 | 0.870 | 0.556 | 0.870 | 0.855 | 0.681 | 0.867 | 0.837 | 0.733 | 0.852 | 0.831 |
| 2000 Hz | 0.572 | 0.892 | 0.913 | 0.692 | 0.881 | 0.858 | 0.732 | 0.862 | 0.843 | 0.773 | 0.840 | 0.834 |
| 2500 Hz | 0.595 | 0.910 | 0.911 | 0.775 | 0.890 | 0.867 | 0.872 | 0.879 | 0.866 | 0.902 | 0.857 | 0.868 |
| 5000 Hz | 0.817 | 0.910 | 0.920 | 0.916 | 0.903 | 0.912 | 0.938 | 0.919 | 0.924 | 0.931 | 0.909 | 0.925 |
| 6300 Hz | 0.854 | 0.904 | 0.914 | 0.912 | 0.913 | 0.910 | 0.943 | 0.934 | 0.933 | 0.935 | 0.923 | 0.934 |
| 8000 Hz | 0.880 | 0.911 | 0.908 | 0.919 | 0.908 | 0.913 | 0.945 | 0.942 | 0.943 | 0.938 | 0.932 | 0.943 |
| 10000 Hz | 0.900 | 0.907 | 0.902 | 0.918 | 0.914 | 0.917 | 0.948 | 0.948 | 0.949 | 0.994 | 0.938 | 0.944 |

TABLE 11

| Sound absorption | | | | | | | | | | | | |
|---|---|---|---|---|---|---|---|---|---|---|---|---|
| coefficient | Comp. Ex. | | | | | | | | | | | |
| improvement range | 8 | 9 | 10 | 11 | 12 | 13 | 14 | 15 | 16 | 17 | 18 | 19 |
| 500 Hz | — | — | — | — | — | — | — | — | — | 0.028 | −0.007 | 0.013 |
| 630 Hz | — | — | — | — | — | — | — | — | — | 0.037 | −0.008 | 0.009 |
| 800 Hz | — | — | — | — | — | — | — | — | — | 0.046 | −0.010 | 0.004 |
| 1000 Hz | — | — | — | — | — | — | — | — | — | 0.053 | −0.009 | 0.002 |
| Low-frequency range | | | | | | | | | | X | X | X |
| evaluation | | | | | | | | | | | | |
| 1600 Hz | — | — | — | — | — | — | — | — | — | 0.052 | −0.015 | −0.006 |
| 2000 Hz | — | — | — | — | — | — | — | — | — | 0.041 | −0.022 | −0.009 |
| 2500 Hz | — | — | — | — | — | — | — | — | — | 0.030 | −0.022 | 0.002 |
| Intermediate-frequency | | | | | | | | | | ◯ | X | X |
| range evaluation | | | | | | | | | | | | |
| 5000 Hz | — | — | — | — | — | — | — | — | — | −0.007 | −0.010 | 0.001 |
| 6300 Hz | — | — | — | — | — | — | — | — | — | −0.008 | −0.011 | 0.001 |
| 8000 Hz | — | — | — | — | — | — | — | — | — | −0.007 | −0.010 | 0.000 |
| 10000 Hz | — | — | — | — | — | — | — | — | — | 0.046 | −0.010 | −0.005 |
| High-frequency range | | | | | | | | | | X | X | X |
| evaluation | | | | | | | | | | | | |

### INDUSTRIAL APPLICABILITY

Since the laminated sound absorbing material of the present invention is particularly excellent in sound absorbing property in the low-frequency range to the high-frequency range, it can be utilized as a sound absorbing material in a field in which noise in the low-frequency range to the high-frequency range is a problem. Specifically, the laminated sound absorbing material can be utilized as a sound absorbing material used for ceilings, walls, floors, or the like of houses, a soundproof wall for highways, railway lines, or the like, a soundproof material for home appliances, a sound absorbing material disposed in each part of vehicles such as railways and automobiles, and the like.

1. A laminated sound-absorbing material, comprising: at least one first layer, and at least one second layer that differs from the first layer, wherein
the first layer has a mean flow pore diameter of 2.0 to 60 μm and an air permeability according to the Frazier method of 30 to 200 cc/cm²·s,
the second layer is a layer comprising at least one kind selected from the group consisting of a foamed resin, a nonwoven fabric and a woven fabric, has a thickness of 3 to 40 mm, and has a density that is lower than the first layer and is 51 to 150 kg/m³, and
the first layer is disposed on a sound incidence side of the second layer.

2. The laminated sound-absorbing material according to claim 1, wherein the second layer is a layer comprising a nonwoven fabric or a woven fabric including: at least one kind of fibers selected from the group consisting of polyethylene terephthalate fibers, polybutylene terephthalate fibers, polyethylene fibers, polypropylene fibers, glass fibers, and natural fibers, or composite fibers wherein two or more kinds selected from the group consisting of polyethylene terephthalate, polybutylene terephthalate, polyethylene, polypropylene, glass, and a natural material are composited.

3. The laminated sound-absorbing material according to claim 1, wherein the first layer comprises fibers including at least one kind selected from the group consisting of polyvinylidene fluoride, nylon 6,6, polyacrylonitrile, polystyrene, a polyurethane, a polysulfone, polyvinyl alcohol, polyethylene terephthalate, polybutylene terephthalate, polyethylene, and polypropylene.

4. The laminated sound-absorbing material according to claim 1, wherein each of the first layer and the second layer is one layer.

5. The laminated sound-absorbing material according to claim 1, wherein a sound absorption coefficient according to a vertical-incidence sound absorption coefficient measurement method at frequencies of 500 to 1,000 Hz is improved by 0.03 or more compared to a sound absorption coefficient of a case in which only one second layer included in the laminated sound-absorbing material is present.

6. The laminated sound-absorbing material according to claim 1, wherein a sound absorption coefficient according to a vertical-incidence sound absorption coefficient measurement method at frequencies of 1,600 to 2,500 Hz is improved by 0.03 or more compared to a sound absorption coefficient of a case in which only one second layer included in the laminated sound-absorbing material is present.

7. The laminated sound-absorbing material according to claim 1, wherein a sound absorption coefficient according to a vertical-incidence sound absorption coefficient measurement method at frequencies of 5,000 to 10,000 Hz is improved by 0.03 or more compared to a sound absorption coefficient of a case in which only one second layer included in the laminated sound-absorbing material is present.
